(19) United States
(12) Patent Application Publication
(10) Pub. No.: US 2004/0008354 A1
(43) Pub. Date: Jan. 15, 2004

(54) Image processing device and image processing method

(75) Inventor: Masanori Asakura, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/613,655

(22) Filed: Jul. 2, 2003

(30) Foreign Application Priority Data
Jul. 11, 2002 (JP) 2002-203033

(51) Int. Cl. G06K 1/00; G06F 15/00

(52) U.S. Cl. 358/1.1; 358/1.9

(57) ABSTRACT

An image processing device includes an isolated point detecting unit that detects isolated points from image data, an isolated point counting unit that counts the isolated points detected by the isolated point detecting unit, and an isolated point eliminating unit that eliminates the isolated points from the image data. When the number of the isolated points counted by the counting unit reaches a threshold value or less, the isolated points are eliminated from the image data by the isolated point eliminating unit.

### BACKGROUND OF THE INVENTION

1. Field of the Invention

The present invention relates to an improvement in an image processing device such as a facsimile machine and an image processing method.

2. Description of the Related Art

In a conventional image processing device such as a facsimile machine, image data scanned by a scanner or image data received by facsimile are printed out by a printer. There are cases when isolated points are included in the image data.

An isolated point means data which one pixel is black, and other pixels around the black pixel are white. In digital halftone image data which is binarized by dither or error diffusion methods, the isolated points become meaningful data. However, there are many cases when the isolated point in the binary image data is noise, and it is preferable to eliminate the isolated points.

However, in the digital halftone image, it is not appropriate to eliminate the isolated points. For example, in image processing during printing out, if the isolated points are eliminated indiscriminately, in the case of the digital halftone image, the quality of the image to be printed out decreases.

### SUMMARY OF THE INVENTION

An advantage of the present invention is to provide an image processing device which can appropriately and automatically determine whether or not to eliminate isolated points for image data to be processed.

According to a first aspect of the present invention, an image processing device of the present invention includes an isolated point detecting unit which detects isolated points from image data, an isolated point counting unit which counts a number of the isolated points detected by the isolated point detecting unit, and an isolated point eliminating unit which eliminates the isolated points from the image data. When the value counted by the isolated point counting unit reaches a threshold value or lower, the isolated points are eliminated from the image data by the isolated point eliminating unit. Therefore, a determination for whether or not to eliminate the isolated points can be carried out appropriately and automatically for the image data to be processed.

According to a second aspect of the present invention, the threshold value is set at different values according to resolution. Therefore, the isolated points can be detected and eliminated appropriately in accordance with the resolution of the image data.

According to a third aspect of the present invention, the image data is divided into a plurality of sections, and the isolated points are counted for each of the sections. When the counted value reaches the threshold value or lower in each of the sections, the isolated points are eliminated from the image data in that section. Therefore, the isolated points can be detected and eliminated appropriately in each of the sections for the image data which includes binary coded image data and digital halftone image data.

### BRIEF DESCRIPTION OF DRAWINGS

FIG. 1 is a view showing an example of relevant parts of an image processing device of the present invention.

FIG. 2 is a view showing an example of a configuration of an isolated point detecting circuit.

FIG. 3 is a flowchart of processing to store a threshold to a register.

FIG. 4 is a view showing resolution which is a subject of determination.

FIG. 5 is a flowchart for describing an operation of a facsimile machine.

### DETAILED DESCRIPTION OF THE PREFERRED EMBODIMENTS

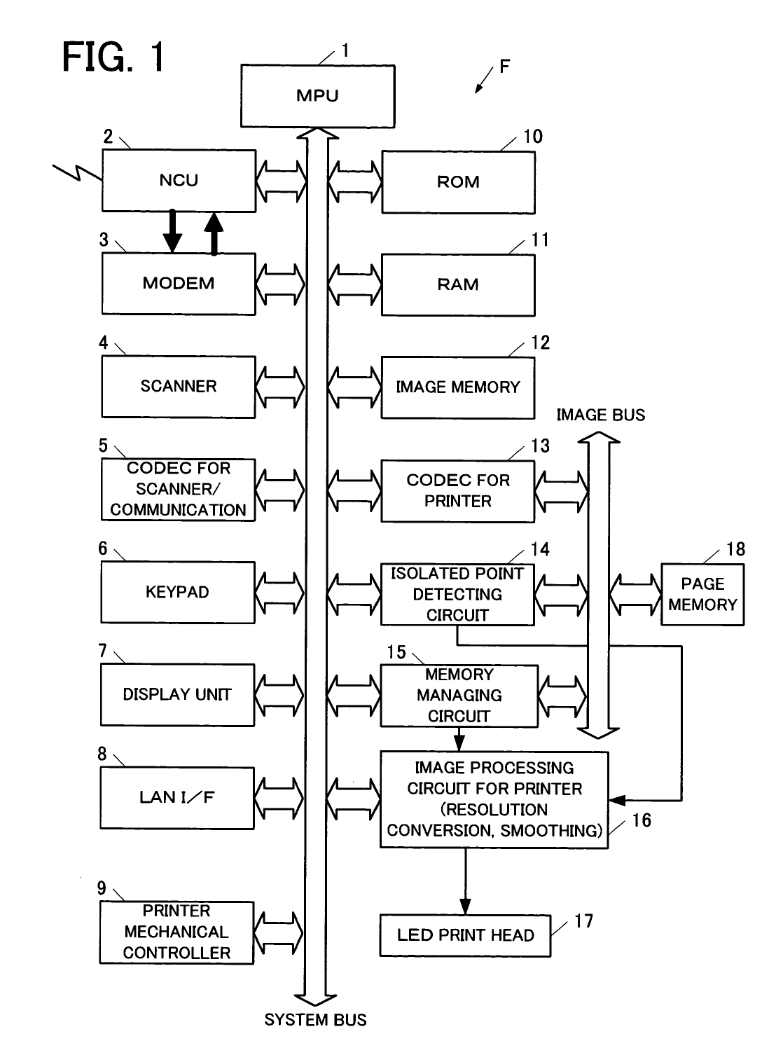

An embodiment of the present invention will be described with reference to the drawings. FIG. 1 is a view showing an example of a configuration of an image processing device of the present invention. Further, the configuration of a facsimile machine F as an image processing device is shown. However, the present invention is not limited to a facsimile machine, and can be applied to a device which can execute various functions and which can be connected to a communication network such as the Internet.

The facsimile machine F includes a Micro Processing Unit (MPU) 1 which controls the facsimile machine F, a Network Control Unit (NCU) 2 which controls a connection to a telephone line, and a modem 3 which modulates and demodulates various signals necessary for a facsimile communication. In addition, the facsimile machine F includes a scanner 4 which scans image and forms image data, a codec for communication 5 which codes and decodes the image data when carrying out a facsimile communication, and a keypad 6 which includes various keys. The facsimile machine F also includes a display unit 7 such as a liquid crystal display, a Local Area Network (LAN) interface 8 which is for establishing a connection to a LAN which is one type of communication network, and a printer mechanical controller 9 which controls a mechanism of a printer. Furthermore, the facsimile machine F includes a Read Only Memory (ROM) 10 which stores various programs necessary for the operation of the facsimile machine F, a Random Access Memory (RAM) 11 which stores speed-dial information or the like, and an image memory 12 which stores the coded image data. The facsimile machine F also includes a codec for printer 13 which decodes the image data when printing out the image data, an isolated point detecting circuit 14, and a memory managing circuit 15. In addition, the facsimile machine F includes an image processing circuit for printer 16 which executes resolution conversion, smoothing or the like of the image data, a Light Emitting Diode (LED) print head 17, and a page memory 18.

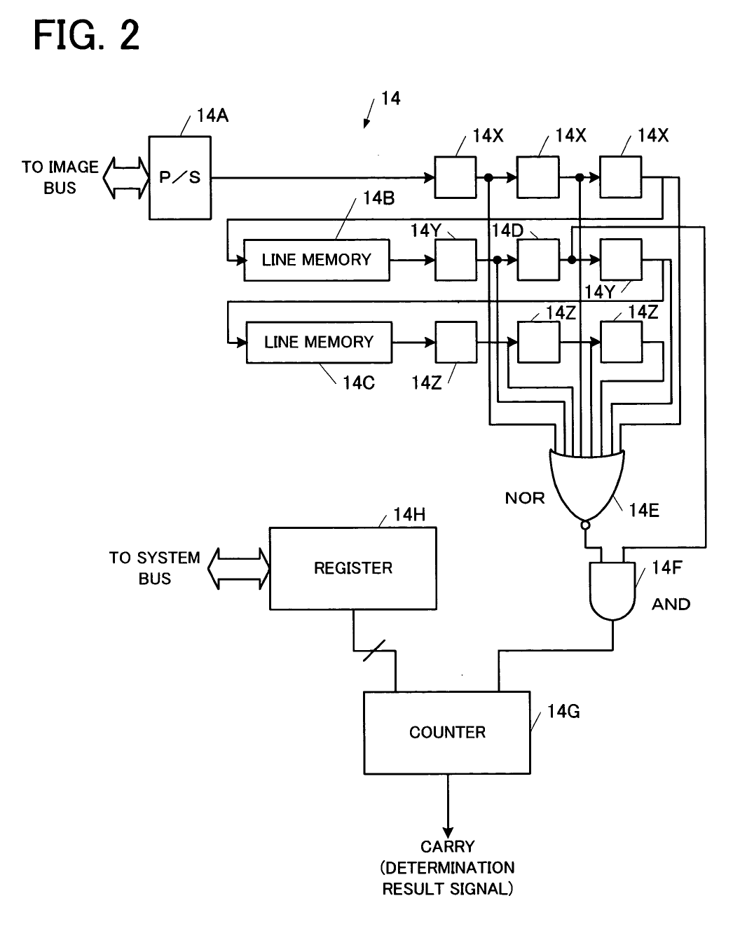

The isolated point detecting circuit 14 has a configuration as shown in FIG. 2. That is, the isolated point detecting circuit 14 includes a parallel-to-serial converter 14A, line memories 14B, 14C, dot memories 14D, 14X, 14Y and 14Z, a NOR gate 14E, an AND gate 14F, a counter 14G, and a register 14H.

In the isolated point detecting circuit 14, the image data to be printed out is output to the parallel-to-serial converter 14A through an image bus, and the image data is converted from parallel data into serial data in the parallel-to-serial converter 14A.

The image data which is converted into serial data as described above passes through the upper dot memories 14X, and is stored in the upper line memory 14B. After the image data is stored for one line, the image data passes through the middle dot memories 14Y, and is stored in the lower line memory 14C. Furthermore, after the image data is stored for one line, the image data passes through the lower dot memories 14Z, and is stored in the page memory 18. The above processing is repeated for each one page of image data.

In this process, under a matrix formed by the dot memories 14D, 14X, 14Y and 14Z, when the image data of the center dot memories 14D is black and the image data of the other dot memories 14X, 14Y and 14Z are white, the input to the NOR gate 14E are “0's”, and the output from NOR gate 14E is a “1”. Further, in the isolated point detecting circuit 14, black is processed as “1” and white is processed as “0”.

Moreover, in this case, “1”'s are input to the AND gate 14F, and a “1” is output from the AND gate 14F.

Then, the counter 14G counts the number of “1's” output from the AND gate 14F. When the counted value is a prescribed threshold value stored in advance in register 14H or less, the image data of the dot memories 14D is determined as the isolated points, and a carry signal (determination signal) is output to the MPU 1.

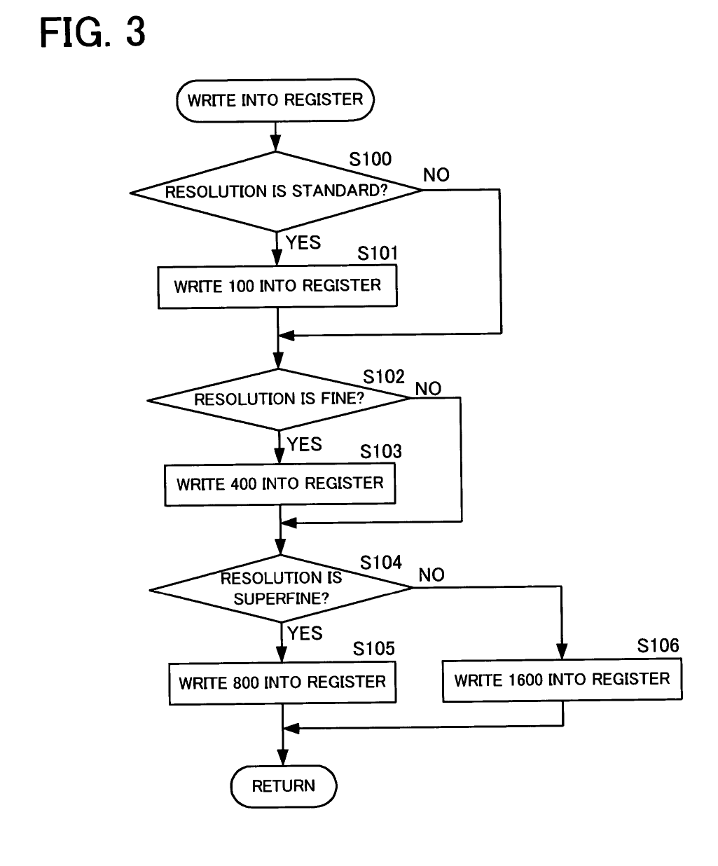

FIG. 3 is a flowchart showing a processing to store the threshold into the register 14H. In the facsimile machine F, the threshold for the register 14H can be set automatically in accordance with a resolution of the image data which is required to be printed out. When the resolution is standard, 100 is written into the register 14H (steps S100, S101).

Moreover, when the resolution is fine, the MPU 1 writes 400 into the register 14H (steps S102, S103). When the resolution is superfine, the MPU 1 writes 800 into the register 14H (steps S104, S105). When the resolution is hyperfine, the MPU 1 writes 1600 into the register 14H (step S106).

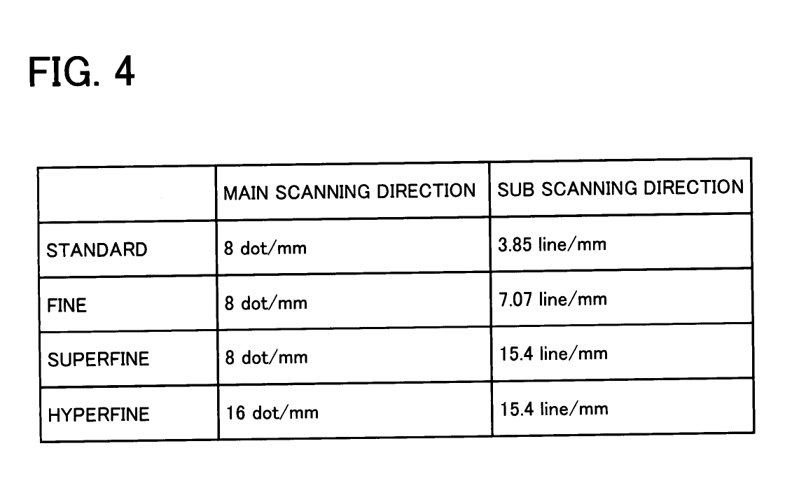

Further, the resolution subject of the determination is as shown in FIG. 4. That is, a facsimile communication protocol determines which resolution the image data corresponds to in FIG. 4.

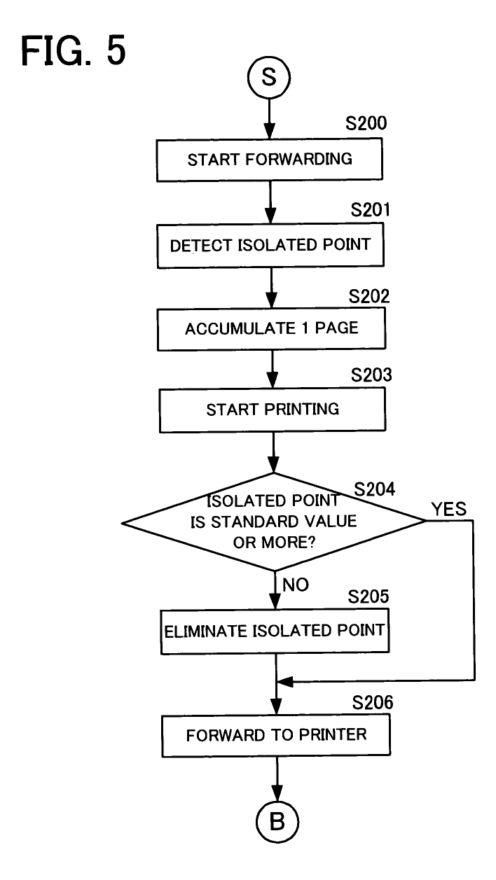

FIG. 5 is a flowchart showing a print out processing of the facsimile machine F including the above-described detection of the isolated points.

In this processing, when forwarding the image data to a printer (step S200), the isolated points in the image data are detected for each page, and the image data is stored into the page memory 18 (step S201). Then, the printer starts to print out. When a number of the isolated points reaches the threshold value or more (step S204), the image data is forwarded to the printer without any elimination, and the image data is printed out (step S206). When the number of the isolated points is less than the threshold value, the isolated point is eliminated by the image processing circuit for printer 16 (step S205).

Further, in the above-described embodiment, the isolated points in the image data are detected and eliminated for the entire page. However, the present invention is not limited to this example. That is, the image data for one page can be divided into several sections, and for each section, the isolated points can be counted. Then, when the counted value reaches the threshold value or less in each of the sections respectively, the isolated points can be eliminated from the image data in that section.

In this case, for example, a method to divide the image data in a sub scanning direction for each N lines is the easiest, and N is preferable to be set at a larger value as the resolution of the image data is higher.

What is claimed is:

1. An image processing device comprising:
an isolated point detecting unit that detects isolated points from image data;
a counting unit that counts the isolated points detected by the isolated point detecting unit; and
an isolated point eliminating unit which eliminates the isolated points from the image data when a number of the counted isolated points reaches a threshold value or less.

2. The image processing device according to claim 1, wherein the threshold value is set at different values according to an image resolution.

3. The image processing device according to claim 1, wherein the image data is divided into several sections, and the isolated points are counted for each of the sections, and when the counted value reaches the threshold value or less for each of the sections respectively, the isolated points are eliminated from the image data in the section.

4. The image processing device according to claim 3, wherein the image data is divided into smaller sections as the resolution of the image data becomes higher.

5. An image processing device comprising:
an isolated point detecting unit that detects isolated points from image data;
a register to which a threshold value is written;
a counter which counts the isolated points detected by the isolated point detecting unit, and outputs a signal when a number of the counted isolated points reaches the threshold value written in the register or less; and
an isolated point eliminating unit which eliminates the isolated points from the image data when the signal is input from the counter.

6. The image processing device according to claim 5, wherein the threshold value is written into the register according to a image resolution.

7. An image processing device comprising:
means for detecting isolated points from image data;
means for counting the isolated points detected by the means for detecting; and
means for eliminating the isolated points from the image data when a counted number of the isolated points reaches a threshold value or less.

8. The image processing device according to claim 7, further comprising means for setting different threshold value according to an image resolution of the image data.

9. The image processing device according to claim 7, further comprising:
means for dividing the image data into several sections;
wherein the isolated points are counted for each of the sections, and when the counted value reaches the threshold value or less in each of the sections, the isolated points are eliminated from the image data in the section.

10. The image processing device according to claim 9, wherein the image data is divided into smaller sections as the image resolution of the image data becomes higher.

11. An image processing method comprising:
detecting isolated points from image data;
counting the detected isolated points;
comparing a number of the counted isolated points with a threshold value; and
eliminating the isolated points from the image data when the number of the isolated points reaches the threshold value or less.

12. The image processing method according to claim 11, further comprising:
determining an image resolution of the image data;
setting a threshold value according to the image resolution; and
comparing the number of the counted isolated points and the set threshold value.

13. An image processing method comprising:
dividing image data into several sections;
detecting isolated points in the image data for each of the divided sections;
counting a number of the detected isolated points for each of the divided sections; and
eliminating the isolated points from the image data for a section when the counted number of the isolated points reaches a threshold value or less for each of the divided sections.

14. The image processing method according to claim 13, further comprising:
determining an image resolution of the image data;
determining a number of sections to divide the image data according to the image resolution; and
dividing the image data into the determined number of sections.

15. The image processing device according to claim 7, further comprising means for storing the threshold value.

16. The image processing device according to claim 2, further comprising a register to store the threshold value.

17. The image processing device according to claim 5, wherein the image data is divided into several sections.

18. The image processing device according to claim 16, wherein the threshold value is stored in the register according to the image resolution.

19. The image processing method according to claim 11, further comprising storing the threshold value.

20. The image processing method according to claim 13, further comprising storing the threshold value.
